(19) United States
(12) Patent Application Publication
(10) Pub. No.: US 2007/0120403 A1
(43) Pub. Date: May 31, 2007

(54) Child seat

(76) Inventor: Joannes Herman Drexler, Angelo (NL)

Correspondence Address: HOFFMANN & BARON, LLP, 6900 JERICHO TURNPIKE, SYOSSET, NY, 11791, US

(21) Appl. No.: 10/518,700

(22) PCT Filed: Jun. 20, 2003
(86) PCT No.: PCT/NL03/00453

§ 371 Date: Nov. 30, 2006

(30) Foreign Application Priority Data
Jun. 20, 2002 (NL) 1020910

(51) Int. Cl. B60N 2/28

(52) U.S. Cl. 297/250.1; 297/410

(57) ABSTRACT

A child seat (1) for use in a vehicle is designed to be placed on a vehicle seat. The child seat (1) comprises a seat part (2) and an upright part (3). The upright part (3) comprises a backrest part (10) that is adjustable in height relative to the seat part (2) and a headrest part (6) that is adjustable in height relative to the seat part (2) and the adjustable backrest part (10). The headrest (6) and the adjustable backrest part (10) are connected to each other, so that a height adjustment of the headrest (6) leads to a different, preferably smaller height adjustment of the adjustable backrest part (10).

The invention relates to a child seat for use in a vehicle, which child seat is designed to be placed on a vehicle seat and comprises a seat part and an upright part, the upright part comprising a backrest part that is adjustable in height relative to the seat part and a headrest part that is adjustable in height relative to the seat part and the adjustable backrest part.

Such a child seat is known. In order to provide optimum safety in the event of a collision, it is important for the height of the headrest and the height of the backrest part to be adapted to the length of the child and to be set in the correct mutual ratio. In the case of the known child's seat the height of the headrest and the height of the adjustable backrest part are adjustable independently of each other. A disadvantage of this is that a height adjustment of both the headrest and the backrest part is laborious and is consequently often not performed properly, for example is not made in the correct mutual ratio.

The object of the invention is to provide a child seat with improved safety.

This object is achieved by a child seat of the type described above, wherein the headrest and the adjustable backrest part are connected to each other, so that a height adjustment of the headrest leads to a different, preferably smaller height adjustment of the adjustable backrest part.

Owing to the fact that the headrest and the adjustable backrest part of the child seat according to the invention are connected to each other in this way, the height adjustment of the headrest and the adjustable backrest part are dependent upon each other. This therefore means that the adjustment of the headrest and the backrest part can be made in one operation and in a fixed, predetermined ratio. A setting of both the headrest and the adjustable backrest part at the correct height and in the correct mutual ratio is guaranteed in the case of the child seat according to the invention, so that better protection, and therefore greater safety, of the child is achieved.

A height adjustment of the headrest preferably leads to a height adjustment of the adjustable backrest part that is approximately half that of the headrest. It has been found that this ratio corresponds well to the height ratio between the head and the back in children of about 1 to 12 years of age.

Further embodiments and advantages of the invention emerge in the description below with reference to the drawing, in which:

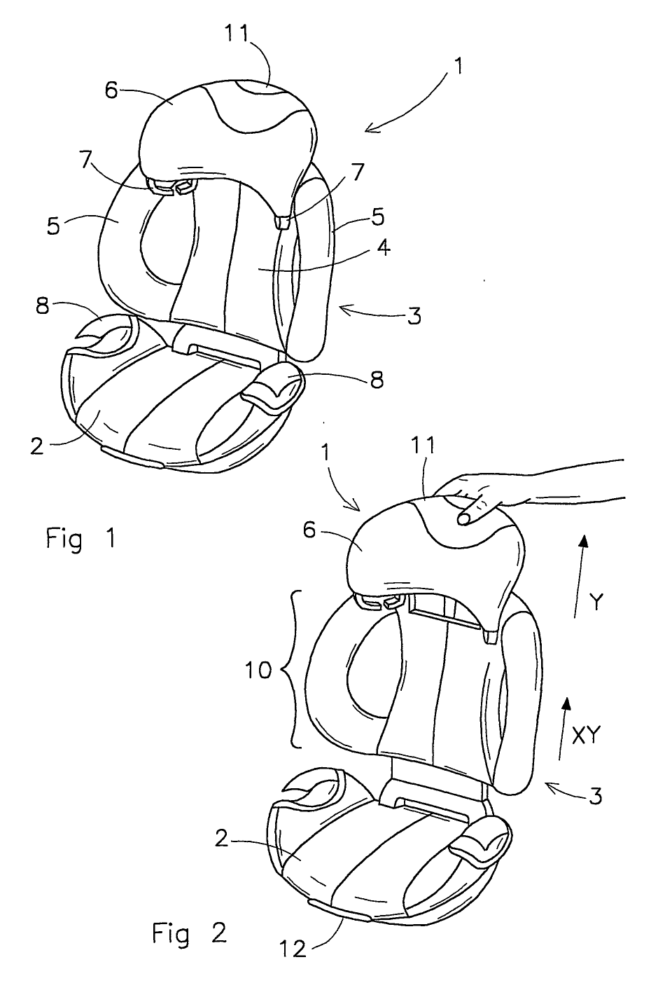

FIG. 1 shows a preferred embodiment of a child seat according to the invention in its smallest position;

FIG. 2 shows the child seat of FIG. 1 in a larger position; and

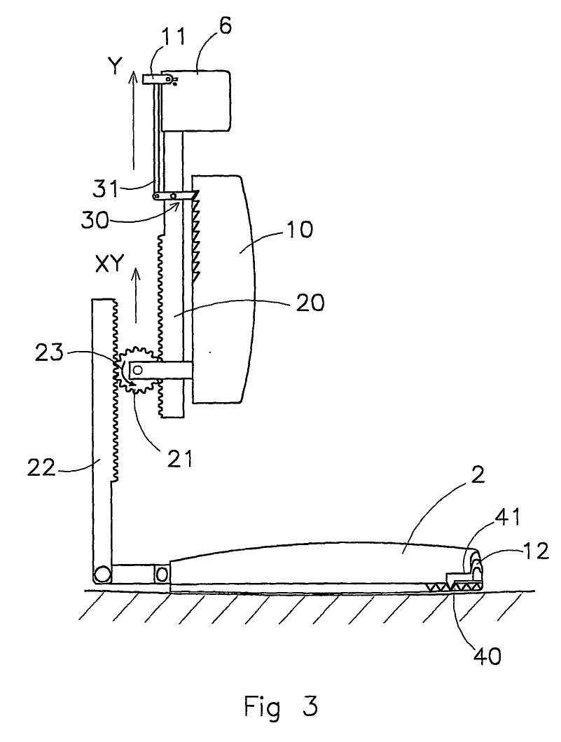

FIG. 3 shows diagrammatically a preferred embodiment of a connection between a headrest part and an adjustable backrest part.

FIG. 1 shows a child seat 1, comprising a seat part 2 and an upright part 3. The upright part 3 comprises a lumbar support 4 and side supports 5, which are provided on either side of the lumbar support 4. The upright part 3 further comprises a headrest 6. The headrest 6 is provided on both sides with a belt guide 7, in which a shoulder part of a car seatbelt can be accommodated. In an alternative embodiment (not shown) the adjustable backrest part can be provided with belt guides for the shoulder part, instead of or in addition to those in the headrest. The seat part 2 is provided on both sides with a belt guide 8, in which a hip part of the car seatbelt can be accommodated. When the child seat 1 shown in the drawing is being used, the child sits down on the seat and the car seatbelt is then placed with the hip part over the child's legs, the hip part of the belt being inserted into the guides 8. During this process the shoulder part of the belt passes along the front of the child, guided in one of the belt guides 7.

As can be seen from FIG. 2, the headrest 6 is adjustable in height relative to the seat part 2. The lumbar support 4 and side supports 5 in this embodiment together form a height adjustable backrest part, which is indicated by reference numeral 10. The adjustable backrest part 10 is adjustable in height relative to the seat part 2. The headrest part 6 is adjustable relative to the adjustable backrest part 10.

The child seat 1 is provided with locking means 30 (see FIG. 3), which lock the headrest part 6 and the backrest part 10 with respect to each other, so that the set height is retained. Of course also locking means with another design can be provided which lock the headrest part 6 and the backrest part 10 in one way or another. A handgrip 11, which is provided on the back of the headrest 6 at the top, is connected to an operating mechanism 31 for unlocking the lock. By operating the handgrip 11, as shown in FIG. 2, the lock is consequently released, and the headrest part 6 and the backrest part 10 can be shifted in height by pulling the headrest 6 up or pushing it down using the handgrip 11.

The headrest 6 is connected to the backrest part 10 in such a way that when the headrest is slid upwards over a distance y relative to the seat part 2, the backrest part 10 moves upwards in the same direction over a distance xy. The distance xy is less than the distance y. The ratio y:xy preferably corresponds to approximately 2:1, because it has been found from ergonomic analysis that this ratio corresponds well to the height ratio between the head and the back in children.

The seat part 2 is also adjustable, it being possible to slide the seat part 2 forwards or backwards relative to the upright part 3. This means that the seat part 2 can also be adapted to the length of the child, so that the child's legs are adequately supported. This position of the seat part 2 is locked by means of locking means 40 (see FIG. 3). A handgrip 12 is provided on the front side of the seat part 2, which handgrip is connected to an operating mechanism 41 for unlocking the seat part 2, so that the latter can be slid forwards or backwards.

FIG. 3 shows diagrammatically how the adjustable backrest part 10 and the headrest part 6 are preferably connected. The headrest 6 is fixedly connected to a gear rack 20. The adjustable backrest part 10 is connected to the centre of rotation of a gearwheel 21 in such a way that the gearwheel 21 can rotate relative to the backrest part 10. The gearwheel 21 meshes with the gear rack 20. The seat 2 is connected to a gear rack 22. The gear rack 22 is in mesh with the gearwheel 21 diametrically opposite the gear rack 20. Starting from an unlocked state, the headrest 6 with the gear rack 20 can be drawn upwards, for example, over a distance y. As a result of this, the gearwheel 21 starts to rotate anticlockwise in the figure, as indicated by the arrow 23. Through the rotation of the gearwheel 21, the gearwheel 21 moves along the teeth of the gear rack 22 over a distance xy, so that the backrest part 10 moves upwards over a distance xy. In the example shown the ratio y:xy is approximately equal to 2:1. A different ratio could be obtained by, for example, a geared transmission (not shown). It must be understood that the ratio of 2:1 as mentioned in the case of this exemplary embodiment must not be regarded as limiting. Other desired ratios such as 3:1 are also quite possible.

Other connections between the headrest 6 and the adjustable backrest part 10 are also possible within the idea of the invention.

One example that could be given is a system of rods (not shown), in which the headrest 6 and the adjustable backrest part 10 are both connected to a lever, the headrest 6 being connected to the lever further away from the centre of rotation than the backrest part 10. This means that during rotation of the lever the headrest 6 travels a longer distance than the backrest part 10. A ratio of y:xy can be selected by selecting the distances of the connections to the lever of the headrest 6 and the backrest part 10 relative to the centre of rotation.

Another possibility (not shown) for connecting the headrest 6 and the backrest part 10 is to use a cable pulley system, in the case of which, for example, the headrest 6 is connected by means of a cable to a frame connected to the seat part 2. The cable is guided by way of a movable pulley, which is connected to the adjustable backrest part 10. By, for example, sliding the headrest 6 upwards, the cable is pulled upwards, so that the pulley also—and therefore the backrest part 10 are slid upwards.

In yet another possible embodiment the headrest 6 is connected by means of a gear transmission to the adjustable backrest part 10, in which case the ratio y:xy can be selected by selecting the ratio of the gearwheel diameters.

In yet another possible embodiment the connection between the headrest 6 and the backrest part 10 comprises a cam disc. The shape of the circumference of the cam disc in that case determines the ratio y:xy.

1. Child seat for use in a vehicle, which child seat is designed to be placed on a vehicle seat and comprises a seat part and an upright part, the upright part comprising a backrest part that is adjustable in height relative to the seat part and a headrest part that is adjustable in height relative to the seat part and the adjustable backrest part, wherein the headrest and the adjustable backrest part are connected to each other, so that a height adjustment of the headrest leads to a different, preferably smaller height adjustment of the adjustable backrest part.

2. Child seat according to claim 1, wherein a height adjustment of the headrest leads to a height adjustment of the adjustable backrest part that is approximately half that of the headrest.

3. Child seat according to claim 1, wherein the headrest and the adjustable backrest part are connected to each other by a gear rack construction.

4. Child seat according to claim 1, wherein the headrest and the adjustable backrest part are connected to each other by a rod mechanism.

5. Child seat according to claim 1, wherein the headrest and the adjustable backrest part are connected to each other by a cable pulley mechanism.

6. Child seat according to claim 1, wherein the headrest and the adjustable backrest part are connected to each other by means of a gearwheel transmission.

7. Child seat according to claim 1, wherein the headrest and the adjustable backrest part are connected to each other by means of a cam disc.

8. Child seat according to claim 1, wherein locking means are provided for the height adjustment.

9. Child seat according to claim 1, wherein the headrest is provided with a handgrip for pulling up or pushing down the headrest for adjusting the height of the headrest and the backrest part.

10. Child seat according to claim 9, wherein locking means are provided for the height adjustment and further wherein the handgrip is connected to the locking means, in order to unlock the lock.

11. Child seat according to claim 1, wherein the seat part is adjustable.

12. Child seat according to claim 1, wherein the headrest is provided with a belt guide.

13. Child seat according to claim 1, wherein the adjustable backrest part is provided with a belt guide.

14. Child seat according to claim 1, wherein the seat part is provided with a belt guide.
